(19) United States
(12) Patent Application Publication
(10) Pub. No.: US 2009/0181735 A1
(43) Pub. Date: Jul. 16, 2009

(54) Reception Boosting Accessory

(76) Inventors: Paul P. Griffin, JR., Nashville, TN (US); David M. Reynolds, Mount Juliet, TN (US)

Correspondence Address: HORNKOHL INTELLECTUAL PROPERTY LAW, P.L.L.C, P.O. BOX 210584, NASHVILLE, TN, 37221, US

(21) Appl. No.: 12/348,004

(22) Filed: Jan. 1, 2009

Related U.S. Application Data
(60) Provisional application No. 61/018,661, filed on Jan. 2, 2008.

(51) Int. Cl. H04M 1/00

(52) U.S. Cl. 455/575.7

(57) ABSTRACT

A carrying case for a portable electronic device includes a coupling element that couples to an antenna of the device without establishing a direct electrical connection. The coupling element increases the reception of the device by increasing the effective size of the antenna. The coupling element is designed to correspond to the reception capabilities of the device for which the case is designed. Preferably, the coupling element is a copper foil that is positioned in the case such that it is adjacent the antenna of the device when the device is held within the case. The copper foil is shaped to correspond to a profile of the device. An antenna and signal amplifier can be used in connection with the coupling element to further boost the device's reception capability.

### CROSS-REFERENCES TO RELATED APPLICATIONS

The present application claims priority from co-pending Provisional Patent Application No. 61/018,661 entitled “Reception Boosting Accessory” filed Jan. 2, 2008.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### FIELD OF THE INVENTION

The present invention is directed toward an accessory for use with an electronic device that electromagnetically couples a signal booster in the case to an antenna of the device to improve the reception of the antenna.

### BACKGROUND OF THE INVENTION

A wide variety of electronic devices utilize antennas to receive or send electromagnetic signals. Unfortunately, a better antenna is typically a larger antenna. On small portable devices in particular, a compromise has to be made between reception capability and size and weight restrictions. Often, a small antenna will function perfectly well for most consumers. However, a limited number of individuals located on the fringes of the device's reception range would strongly prefer better reception. While a device can be retrofitted with a more capable antenna, it is difficult to do so in a suitable, ascetic and economical matter.

Cases are commonly used to carry a variety of portable electronic devices such as digital music players, cellular telephones, personal computers, data assistants, etc. Unfortunately, these cases may impede the reception of the device's antenna when the device is positioned within the case. This can further exacerbate the reception problems encountered in some locations. Many cases also suffer from the draw back that the device's outputs, display and controls are not easily accessible through the case's exterior. Since each type of device tends to have a different configuration with respect to their inputs and outputs, even devices that are similarly sized may require different case configurations to accommodate their particular set of inputs and outputs.

In light of the above discussed problems what is needed is an accessory for an electronic device that improves the device's reception.

### SUMMARY OF THE INVENTION

An embodiment of the present invention is directed toward a carrying case for use with a portable electronic device. The carrying case includes a conductive material such as copper foil that functions as a coupling element. The coupling element is positioned in the case such that it is adjacent an antenna of the device when the device is held in the carrying case. The coupling element capacitively or inductively couples to the device antenna and improves the reception of the device. The coupling element is preferably shaped to correspond to a profile of the antenna in the device. A case antenna is electrically connected to the coupling element. The case antenna can be internal or extendable and adjustable. A signal booster may be included in the case to amplify the signal received by the case antenna. The amplified signal is then coupled to the device antenna by the coupling element thereby boosting the device's reception. A rechargeable battery powers the signal booster. Alternatively, the signal booster can be powered from the device power supply in a parasitic manner.

Another embodiment of the present invention is directed toward an accessory for an electronic device. The accessory is configured as a replacement panel for a housing of the device. The replacement panel includes a signal boosting element positioned in the panel. The signal boosting element is positioned in the replacement panel such that, when the replacement panel is installed on the device, the signal boosting element is adjacent an antenna of the electronic device. The signal boosting element couples to the device's antenna thereby improving the reception of the device.

Yet another embodiment of the present invention is directed toward a case for an electronic device. The case includes a front panel and back panel that connect to substantially enclose the electronic device. A repositionable coupling element is positioned on one of the panels such that it is held adjacent an internal antenna of the device. The coupling element, the exterior of the device and the internal antenna of the device form a capacitor that increases the reception capability of the device. An antenna and amplifier are electrically connected to the coupling element. The coupling element couples the amplified signal received from the amplifier to the antenna of the device when the device is held in the case. A shielding portion prevents unwanted signals from the device from coupling to the coupling element.

### BRIEF DESCRIPTION OF THE SEVERAL VIEWS OF THE DRAWINGS

FIG. 1 is an illustration of a device case constructed in accordance with a first embodiment of the present invention;

FIG. 2 is an illustration of a device case constructed in accordance with an alternative embodiment of the present invention;

FIG. 3 is an illustration of a device case constructed in accordance with another alternative embodiment of the present invention;

FIG. 4 is an illustration of an accessory for a device constructed in accordance with an embodiment of the present invention; and

FIG. 5 is a block diagram of an accessory constructed in accordance with an embodiment of the present invention;

### DETAILED DESCRIPTION OF THE INVENTION

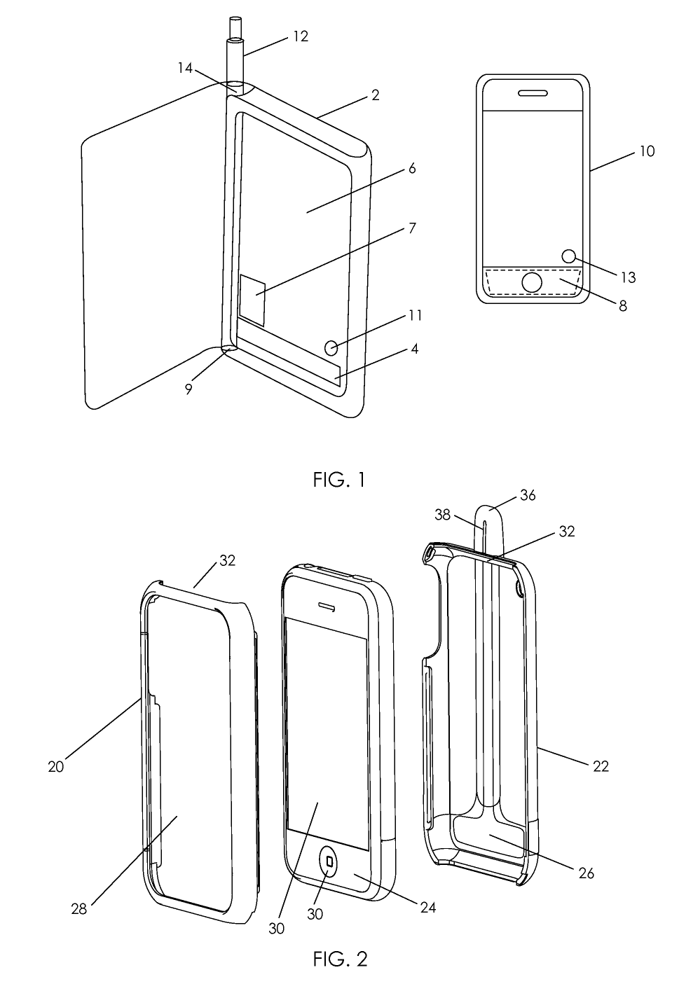

Referring now to FIG. 1, an illustration of a device case 2 constructed in accordance with an embodiment of the present invention is shown. The case 2 has a capacitively coupling element 4, constructed from a conductive material such as copper foil, positioned on an inner face 6 of the case. The coupling element 4 is preferably positioned adjacent an internal antenna 8 of an electronic device 10 when the device is enclosed within the case 2. The capacitively coupling element 4 and the device's internal antenna 8 form the plates of a capacitor and couple to the internal antenna 8 of the electronic device 10 to the element 4 of the device 10. A shielding portion 7, also constructed from a conductive foil, can be constructed to minimize any undesirable coupling to the coupling element 4 from electronics other than the antenna 8 in the device 10. The coupling element 4 can be electrically connected to an extendable antenna 12 that can be retracted into the spine 14 of the case 2 for additional enhanced reception performance. The antenna 12 can also be adjustable such that it can be twisted, bent or rotated to maximize the reception boosting functionality of the case.

An external connector 9 on the case 2 allows an external power source to be coupled to the device 10 through the case 2. A mating connector 11 on the interior of the case 2 couples to a corresponding connector 13 on the device. Power received from the connector 9 can thus be provided to the device when the device is contained within the case 2. The case 2 can also contain power conversion circuitry such that an incompatible power supply can be coupled to the device 10 through the case 2.

Referring now to FIG. 2, an illustration of a device case constructed in accordance with an alternative embodiment of the present invention is shown. The device case is constructed from two faces or panels 20 and 22 that snap together to enclose the portable electronic device 24. An opening 28 in the front panel 20 allows the controls 30 of the device to be accessed through the panel 20. In addition, recesses 32 in each panel 20 and 22 form openings when the panels 20 and 22 are joined such that inputs and outputs of the device 24 can be accessed while the device enclosed within the panels 20 and 22. An electromagnetic coupling element 26 is positioned on the appropriate case panel 20 and 22 such that it is adjacent the internal antenna of the device 24 when the device 24 is enclosed within the case. The coupling element 26 couples received signals to the internal antenna of the device 24 thereby improving the device's reception.

In many situations, the coupling element 26 alone will provide enough of a boost in reception for the device 24. However, the coupling element 26 can also be connected to an antenna and signal booster 38 to further improve the reception of the device if desired as described in more detail herein. The antenna and signal booster 38 can be constructed on a single chip that receives and amplifies the desired radio frequency signal. The amplified signal is then connected to the coupling element 26 which couples the signal to the internal antenna of the device 24. The reception properties of the antenna and signal booster 38 are selected to correspond to the frequencies being received by the device for which the case is designed. This allows for better reception improvement than that provided by prior non-customized signal boosters.

Different coupling elements 26 can be positioned on the back face 22 to maximize coupling with the internal antennas of different types of electronic devices 24. If a conductive foil is used, the foil should be placed as close as possible to the location of the internal antenna of the device 24. The element 26 may be constructed from an adhesive pad that can be repositioned on the case panel 22, by a user or factory personnel, such that a single case design can accommodate different types of devices 24. In addition, the element 26 is preferably shaped to correspond to a profile of the internal antenna of the device 24.

For devices having a plastic or dielectric covered external stub antenna 36, a coupling element in the form of a conductive tube constructed from opposing halves 34 on the case panels 20 and 22. These types of antennas are commonly found on cellular phones. The conductive tube 34, the device antenna 36 and the antenna's covering form a capacitor that couples signals received by the conductive tube 34, and any antenna or signal booster 38 to which it is connected, to the antenna 36 of the device 24. Due to the complex electromagnetics involved, the most suitable coupling element 26 configuration for a particular type of device 24 is most easily determined experimentally on a case by case basis. Since the case is already being designed for a particular type of device, this type of custom configuration is relatively easy to incorporate into the case's design phase.

A capacitive coupling element allows a signal boosting case to be designed for almost any pre-existing device. However, an inductive coupler, such as circular wire coil, may be used instead of a conductive tube 34 to inductively couple the signal booster 38 to the antenna 36 of the device 24. Inductive coupling performs best when the device is purposely designed to receive an inductively coupled reception signal from a specially designed case since the device may not have an antenna design that is receptive to inductive coupling. In an inductively coupled embodiment, an inductive coupler is positioned in the device such that it can couple to an inductive coupler in the case. This allows the case to inductively transfer a boosted reception signal to the case.

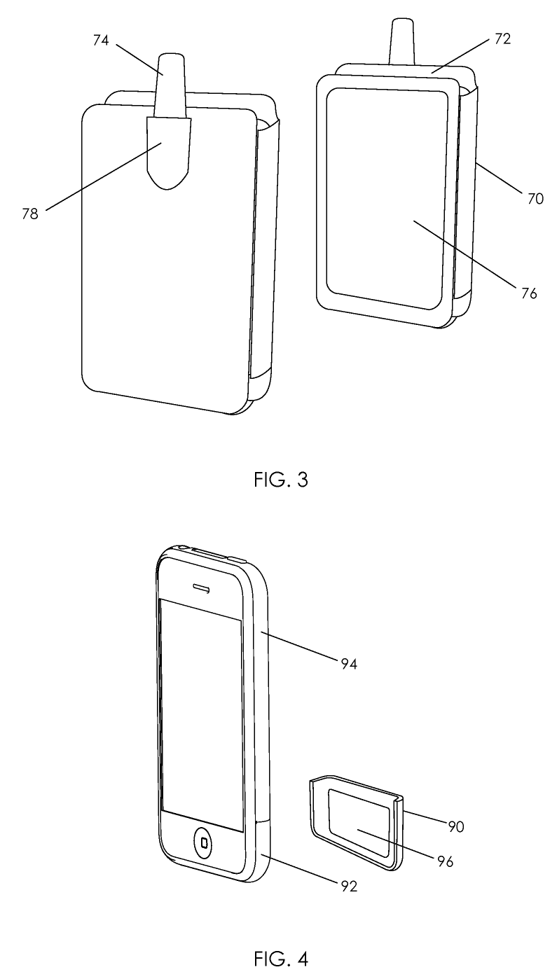

Referring now to FIG. 3, an illustration of a device case constructed in accordance with another embodiment of the present invention is shown. The case 70 is a pocket style case that includes an opening 72 at the top that allows the electronic device to be inserted into the case. A signal boosting coupling element 74 is positioned on a surface of the case. The element 74 is positioned on the case such that it is adjacent the antenna of device when the device is inserted into the case 70. This is easily accomplished since the case 70 must already be designed to accommodate a particular type or class of device. The case 70 includes openings or windows 76 that allow the controls and display of the device to be accessed when the device is held in the case 70. A shielding portion 78 may be included on the case 70 to prevent certain undesirable device electronics from coupling to the coupling element 74 of the device.

Referring now to FIG. 4, an accessory 90 for a device 94 constructed in accordance with an embodiment of the present invention is shown. The accessory is constructed in the form of an existing device housing panel 92, such as a battery cover. The existing device panel 92 is removed and replaced with accessory 90. The accessory 90 includes a signal boosting element 96 that couples to an internal antenna of the device 94 when the existing panel 92 is replaced with the accessory 90. This allows an aftermarket signal boosting accessory 90 to be designed for a device 94 that can be incorporated into the device in an invisible manner that does not affect the ascetics or portability of the device.

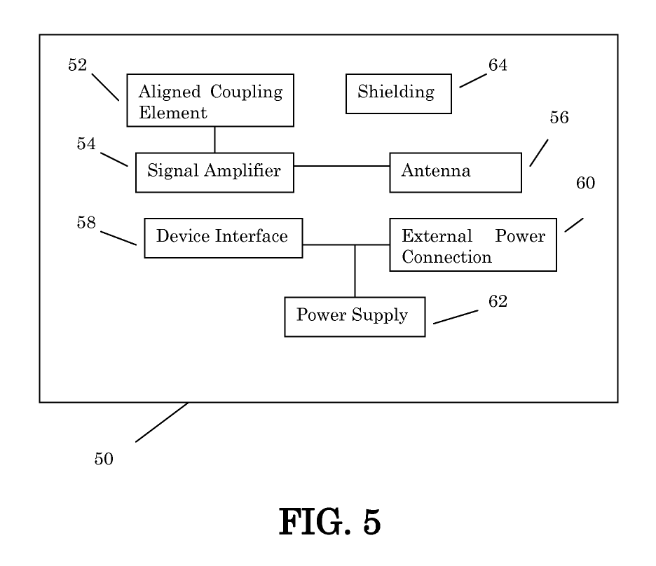

Referring now to FIG. 5, a block diagram of a signal boosting case 50 constructed in accordance with an embodiment of the present invention is shown. The case 50 has an antenna 56 that is adapted to receive or transmit the frequencies utilized by the device for which the case 50 is designed. A signal amplifier 54 receives a signal from the antenna 56 and produces an amplified signal that is applied to the coupling element 52 of the case 50. The signal amplifier 54 can be constructed on a single board computer and include a microcontroller if desired. The aligned coupling element 52 couples the signals received from the amplifier 54 to the device that is positioned in the case 50. The aligned coupling element 52 is positioned within the case to maximize coupling between the coupling element 52 and device antenna. The signal amplifier 54 can be constructed on a single board computer and include a microcontroller if desired.

A power supply 62 such as a rechargeable battery is included in the case 50 to power the amplifying circuitry. An external power connection 60 is used to charge the power supply 62 and provide power to the device when it is held in the case 50 through a device interface 58. A shielding portion 64 may be provided on selected case 50 surfaces to prevent undesirable electronics in the device from coupling to the coupling element 52.

While the embodiments of the present invention have been primarily described with respect to boosting the reception capabilities of a device, those skilled in the art will appreciate that they can also be used to boost the transmission capabilities of a device.

Although there have been described particular embodiments of the present invention of a new and useful RECEPTION BOOSTING ACCESSORY, it is not intended that such references be construed as limitations upon the scope of this invention except as set forth in the following claims.

1. An accessory for a portable electronic device, said accessory comprising:
a coupling element adapted to positioned on an exterior of said device adjacent an antenna of said device for coupling to said an antenna and improving a reception of said device.

2. The accessory of claim 1 further comprising an accessory antenna electrically connected to said coupling element.

3. The accessory of claim 2 further comprising a signal booster for amplifying a signal received by said accessory antenna electrically connected to said coupling element.

4. The accessory of claim 1 wherein said coupling element comprises a conductive material.

5. The accessory of claim 4 wherein said conductive material is shaped to correspond to a profile of said antenna in said device.

6. The accessory of claim 1 wherein said coupling element capacitively couples to said antenna.

7. The accessory of claim 1 wherein said accessory is a carrying case for said device.

8. The accessory of claim 1 wherein said accessory is configured as a replacement panel for a housing of said device.

9. A case for an electronic device, said case comprising:
a signal boosting element positioned in said case to couple to an antenna of said electronic device when said device is held in said case.

10. The case of claim 9 wherein said signal boosting element further comprises a copper foil shaped to correspond to a profile of said antenna of said device.

11. The case of claim 9 wherein said case further comprising a front panel and back panel that connect to substantially enclose said electronic device.

12. The case of claim 9 wherein said signal boosting element further comprises an antenna.

13. The case of claim 10 wherein said antenna is retractable.

14. The case of claim 9 wherein said signal boosting element further comprises an amplifier and rechargeable battery.

15. An accessory for a portable electronic device, said accessory comprising:
a coupling element that is positioned on an exterior of said device adjacent an internal antenna of said device such that said coupling element, said exterior of said device and said antenna of said device form a capacitor that increases a reception capability of said device.

16. The accessory of claim 15 further comprising a carrying case for holding said device wherein said coupling element is positioned on an interior of said carrying case.

17. The accessory of claim 16 wherein said carrying case includes an opening for a device input or output.

18. The accessory of claim 15 wherein said coupling element further comprises a conductive foil.

19. The accessory of claim 18 wherein said conductive foil is shaped to correspond to a profile of said internal antenna.

20. The accessory of claim 15 further comprising an antenna and amplifier connected to said coupling element.
